(19) United States
(12) Patent Application Publication
(10) Pub. No.: US 2026/0336033 A1
(43) Pub. Date: Oct. 29, 2026

(54) MACHINING HEAD AND METHOD FOR THE LASER-BEAM CUTTING OF COMPONENTS

(71) Applicant: Fraunhofer-Gesellschaft zur Förderung der Angewandten Forschung E.V., München (DE)

(72) Inventors: Madlen BORKMANN, Dresden (DE); Patrick HERWIG, Dresden (DE)

(21) Appl. No.: 19/107,087

(22) PCT Filed: Aug. 22, 2023
(86) PCT No.: PCT/EP2023/073010

§ 371 Date: Feb. 27, 2025

(30) Foreign Application Priority Data
Aug. 21, 2022 (DE) 10 2022 209 031.4

(51) Int. Cl. B23K 26/38; B23K 26/14

(52) U.S. Cl. CPC B23K 26/38; B23K 26/14

(57) ABSTRACT

In a machining head, a cutting gas, as first gas stream, and a laser beam are directed at a component to be cut through a nozzle. The cutting-gas feed is enclosed by an annular or polygonal split nozzle or by an annular or polygonal arrangement of individual nozzles that are arranged separately from one another. A second gas stream is directed through the annular or polygonal split nozzle or the nozzles of the annular or polygonal arrangement. The pressure of the cutting gas and the pressure of the second gas stream can each be adjusted independently of one another and a pressure of the cutting gas at the outlet opening of the nozzle for the cutting gas is greater than the pressure of the second gas stream but at most three times as great.

The invention relates to a processing head which is configured for laser beam cutting of components and a method for laser beam cutting. These may preferably be metal components.

When cutting with laser radiation, a coaxially arranged gas jet is used as the cutting gas to expel the material melted by the laser beam from the cutting gap. Almost vertical grooves are formed on the cutting edge, especially when performing laser-cutting of metals. These significantly determine the roughness of the cut edges and form typical horizontal zones with characteristic properties in terms of wavelength and roughness. Furthermore, the grooves are spatially related to the burr formation on the lower edge of the cut material and are therefore a quality-determining feature for the cutting result.

Nozzles arranged coaxially to the laser beam are usually used to shape the gas jet, the diameter of said nozzles generally being significantly larger than the resulting cutting gap. In addition to simple, e.g. conically tapered nozzles, there are also nozzle concepts with internal division of the gas flow into separate flow paths within the nozzle, which are brought together again in or below the respective nozzle and on the workpiece. It is also common for the in-side and underside of the nozzle to be specially designed in order to influence the flow properties of the cutting gas.

To reduce gas loss on the upper side of a component to be cut and to improve gas utilization, an attachment nozzle concept has also been used to date, in which a movable outer ring of the nozzle is guided directly over the workpiece surface.

However, none of the nozzle concepts have so far succeeded in significantly influencing the structure formation on the surfaces of the cutting edges or even completely preventing groove formation.

For example, JP 2011-224 600 A shows how a laser beam may be used to form holes in workpieces.

WO 2018/008400 A 1 relates to laser processing, in particular of plastic parts reinforced with carbon fibres.

A laser welding method and a corresponding device are described in EP 1 153 696 A 2 .

JP H06-304 777 A shows possibilities for hermetically sealing batteries.

It is therefore the object of the invention to specify ways of achieving an improved surface quality on cutting edges obtained by laser beam cutting, where possible without additional post-processing.

According to the invention, this object is achieved with a processing head having the features of claim 1. Claim 9 relates to a method for laser beam cutting. Advantageous embodiments and developments of the invention may be realized with features described in dependent claims.

The processing head according to the invention has, along its central longitudinal axis, a cutting gas feed through which a cutting gas as the first gas flow and a laser beam are directed through a nozzle arranged in the direction of the component towards a component to be cut to form a cutting gap. The cutting gas feed is enclosed, at least in the region of the nozzle of the cutting gas feed, by an annular or polygonal slit nozzle or by an annular or polygonal arrangement of individual nozzles arranged separately from one another and is arranged in such a way that the nozzle of the cutting gas feed is arranged in the centre of the circle defined by the annular slit nozzle or the nozzles of the annular arrangement or centre of gravity of the polygonal slit nozzle or the polygonal arrangement of nozzles. A second gas flow is directed through the annular or polygonal slit nozzle or the nozzles of the annular or polygonal arrangement in the direction of the respective surface of the component to be cut. The pressure of the cutting gas supplied through the nozzle of the cutting gas feed and the pressure of the second gas flow, which flows through the annular or polygonal slit nozzle or the nozzles of the annular or polygonal arrangement, are each adjustable independently of one another. In addition the pressure of the cutting gas supplied through the nozzle of the cutting gas feed at the outlet opening of this nozzle is greater than the pressure of the second gas flow at the outlet opening(s) of the annular or polygonal slit nozzle or the outlet openings of the nozzles of the annular or polygonal arrangement. The pressure in the nozzle of the cutting gas feed is a maximum of three times the pressure of the second gas flow at the outlet opening(s) of the annular or polygonal slit nozzle or the outlet openings of the nozzles of the annular or polygonal arrangement. This refers in essence to the pressures in the region of the outlet openings of the nozzle for cutting gas and the annular or polygonal slit nozzle or the nozzles of the annular or polygonal arrangement.

Advantageously a pressure of the cutting gas supplied through the nozzle should be set at the outlet opening of the nozzle for the cutting gas which is at least 1.5 times as great and at most twice as great, in particular at least 1.7 and at most 1.9 times as great, as the pressure of the second gas flow at the outlet opening(s) of the annular or polygonal slit nozzle or the nozzles of the annular or polygonal arrangement.

The nozzle opening through which the cutting gas emerges from the nozzle should preferably have an inner diameter that corresponds to the outer diameter of the laser beam used for cutting, so that groove formation on the cutting edge may be avoided to an even better extent.

Nozzles arranged in an annular or polygonal arrangement should be geometrically designed, dimensioned and spaced apart in such a way that a second gas flow emerging from their outlet openings may be formed, which surrounds the cutting gas flow in an annular or polygonal shape and the second gas flow is formed at least almost as a closed ring in which at least almost the same flow velocities and pressures are maintained over its circumference.

For a polygonal shape, geometries with at least four corners are preferable.

The nozzles of an annular or polygonal arrangement may be rotationally symmetrical and/or slot-shaped, at least in the region of their outlet openings with their free cross-sectional areas, through which gas for the second gas flow passes. Slots may also be shaped in the form of partial circles concave in the direction of the nozzle for the cutting gas. It is possible to select free cross-sections of the same design and dimensions on the nozzles of the respective annular or polygonal arrangement, but it is also possible, for example, to alternate between differently designed and dimensioned free cross-sectional areas on nozzles of an annular or polygonal arrangement.

The pressure in the region of the outlet openings of the nozzles of the second gas flow should be maintained in the range between 0.05 MPa and 2.5 MPa relative to the ambient pressure, whereby flow velocities of more than 300 m/s may be achieved for the gases emerging from the outlet nozzles. For laser beam cutting with oxygen, pressures in the range of 0.05 MPa to 0.1 MPa are preferably used.

The nozzle of the cutting gas feed, annular or polygonal slit nozzle and/or the nozzles of the annular or polygonal arrangement should advantageously be convergent in the direction of their outlet opening(s), so that the smallest free cross-section through the cutting gas or the second gas flow is/are arranged at the outlet opening of the nozzle for the cutting gas feed or the annular or polygonal slit nozzle or the outlet openings of the nozzles of the annular or polygonal arrangement. In particular and preferably, the respective inner lateral surfaces on the outward-facing surface of the respective nozzle may be formed so as to taper continuously in the direction of the central longitudinal axis of the cutting gas feed, i.e. towards the centre of the outlet opening of the nozzle on the cutting gas feed over a length starting at least 15 mm before the respective outlet opening is reached. At least 40 % of the circumferential surface of the respective inner lateral surface should be conically tapered.

The cone angle may be greater on the inner wall of the annular or polygonal slit nozzle or the nozzles of the annular or polygonal arrangement than on the nozzle of the cutting gas feed. This ensures that the pressure of the individual gas flows is maintained up to the outlet openings and prevents a reduction in the energy content of the cutting gases that may be converted into work within the processing head.

The continuously conically tapering form may influence the pressure and flow velocity distribution within the respective nozzle and prevent the cutting gas from accelerating to supersonic velocity within the respective nozzle.

The laser beam should be directed coaxially through the nozzle of the cutting gas feed towards the component and should preferably have a beam cross-sectional area which fills at least 80% and at most 100% of the free cross-section of the nozzle of the cutting gas feed in the region of its outlet opening. As a result, gap widths may be realized at the formed cutting gap during laser beam cutting that correspond to the inner diameter of the outlet opening of the nozzle for the cutting gas.

The smallest inner diameter of the nozzle of the cutting gas feed at the outlet opening should correspond to the gap width of the cutting gap to be formed with a maximum deviation of ±20% and should be in the range between 0.5 mm and 2 mm. Preferably, this smallest inner diameter should correspond exactly to the gap width of the cutting gap to be formed.

The width of the slit of the annular or polygonal slit nozzle or the width or the outer diameter of the nozzles of the annular arrangement correspond at least to the width of the inner diameter of the nozzle of the cutting gas feed in the region of its outlet opening and is preferably twice this inner diameter.

The outer diameter in the region of the outlet opening may be at least twice as large as the diameter of the nozzle of the cutting gas feed at its outlet opening and may be a maximum of 10.00 mm.

In the case of a polygonal slit nozzle or a polygonal arrangement of nozzles, a maximum distance parallel to the cutting gap to be formed of the respective oppositely arranged outlet opening(s) is maintained which is smaller than the maximum distance of the outlet opening(s) arranged in an axial direction aligned perpendicular thereto. For example, with a rectangular slit nozzle or arrangement of nozzles, a length of the rectangle of approximately 10 mm may be selected, wherein these longer edges should then point parallel to the direction of the cutting gap or feed movement. The length of the perpendicularly aligned edges may then be 2 mm to 5 mm.

A square shape is advantageous compared to a triangle or geometries with more than four corners. A square may be selected of which the longer edges are preferably aligned at least approximately parallel to the cutting gap to be formed as compared to the width of the edges that are aligned perpendicular to it. A length to width ratio of at least 5 to 1 is particularly favourable.

The distance between the outlet openings of the nozzle of the cutting gas feed and the annular or polygonal slit nozzle or the nozzles of the annular or polygonal arrangement to the surface of the component to be cut should differ by a maximum of 1 mm and a distance of the outlet nozzles to the component surface on which the cutting gap is to be formed with the laser beam in the range between 0.2 mm and 2 mm should be maintained during the laser beam cutting processing.

The invention may therefore involve a nozzle arrangement with an inner nozzle opening and an annular gap nozzle concentrically surrounding it or concentrically arranged nozzles of an annular arrangement, wherein the centrally arranged outlet opening through which cutting gas emerges and the annular gap nozzle or the nozzles of the annular arrangement each have a separate gas feed with independently adjustable or controllable gas pressure. The respective gas pressure may be influenced by means of valves arranged in the respective gas feed. In the case of a polygonal slit nozzle or a polygonal arrangement of nozzles, the nozzle from which the cutting gas emerges should be arranged in the respective centre of gravity of the polygon.

The outer diameter of the outlet opening through which the cutting gas emerges from the processing head should correspond approximately to the cutting gap width, preferably it should be the same size as the gap width of the kerf. The diameter of the annular slit nozzle or the diameter of the ring in which the nozzles of an annular arrangement are arranged may be a multiple of the cutting gap width. The outlet opening for the cutting gas may preferably be arranged at the same height as the annular or polygonal slit nozzle or the nozzles in an annular or polygonal arrangement above the surface of the component to be cut, or even slightly above or below it.

The outlet opening distance from the component surface used for cutting may be smaller than the diameter of the outlet opening from which the cutting gas exits the processing head.

The gas pressures or the pressure ratio should preferably be set so that a pressure ratio of the absolute pressures between the inner arranged outlet opening for the cutting gas and the outlet opening(s) of the annular or polygonal slit nozzle or the outlet openings of the nozzles of the annular or polygonal arrangement pᵢ/pₐ of less than 2 results.

The gas feed for the internal nozzle for the cutting gas may be provided via the standard cutting gas feed in the processing head. The gas feed to the annular or polygonal slit nozzle or the nozzles of the annular or polygonal arrangement may be realized via additional connections to the processing head. With an absolute pressure of 2.0 MPa at the outlet opening of the nozzle for the cutting gas, it is particularly advantageous to set the absolute pressure of the second gas flow at the outlet opening of the annular or polygonal slit nozzle or the outlet openings of the nozzles of the annular or polygonal arrangement to 1.1 MPa.

The interior of the nozzle for the cutting gas may be formed as a convergent nozzle, at least in the region near its outlet opening, in which the smallest diameter is arranged at the outlet opening.

The smallest diameter of the nozzle of the cutting gas feed at the outlet opening should almost correspond to the gap width of the cutting gap to be formed and a maximum deviation of the smallest diameter in relation to the gap width of ±20%, preferably ±10%, should be observed.

A laser beam with a beam cross-sectional area of at least 80% and a maximum of 100% of the free cross-section of the nozzle of the cutting gas feed in the region of its outlet opening produces a cutting gap with a width approximately the same size as the outlet opening of the cutting gas. This ensures that the cutting gas flow enters the produced cutting gap directly and in a straight line. Compared to the prior art, the upper edge of the cutting gap then does not act as a flow obstacle in the form of a forward-facing step and the cutting gas flow may enter the cutting gap undisturbed. With the invention, the separation of the inflowing cutting gas from the upper edge of the cutting gap and the formation of a recirculation area at the upper edge of the gap may thus be prevented during laser beam cutting. In comparison to the prior art, this prevents or greatly reduces the accumulation of spatial and temporal disturbances in the boundary layer of the cutting gas flow on the cutting edge and the cutting gas flow may achieve a uniform expulsion of the melt formed with the energy of the laser beam from the kerf.

The outer annular or polygonal slit nozzle or the nozzles of the annular or polygonal arrangement may be used to prevent contamination of the cutting gas by gas from the surrounding environment and to shield the formed melt. This prevents oxidation in the process zone during fusion cutting with an inert process gas, preferably nitrogen and an annular gap flow or an annular or polygonal second gas flow with an equally inert process gas. If, on the other hand, in laser cutting oxygen is used as the cutting gas, with which energy is provided to the process for melting the material through oxidation and the melt is to be expelled from the kerf, oxygen or an inert process gas such as nitrogen may also flow in the direction of the component surface through the annular or polygonal slit nozzle or the nozzles of the annular or polygonal arrangement, whereby an influence on the oxygen content in the cutting gas reaching the melt may be achieved.

The outer annular or polygonal slit nozzle or the nozzles of the annular or polygonal arrangement may be used to increase the effective range of the cutting gas for melt distribution in the slit and thus the material thickness able to be cut.

By taking into account the pressure ratio at the outlet openings for the cutting gas, the annular or polygonal slit nozzle or the nozzles of the annular or polygonal arrangement of less than a maximum of 2, the pressure distribution between the outlet openings of the nozzles and the component surface may be adjusted in such a way that the cutting gas flowing out of the outlet opening may be prevented from reaching sonic velocity. This means that no shocks are formed in the outgoing cutting gas flow and the flow within the cutting gap, which means that the energy of the gas that is able to be converted into work may be increased compared to the prior art and the disturbance of the gas boundary layer in the process zone may be suppressed by shock-boundary layer interactions. At pressure ratios between 2 and 3 of the absolute pressures at the outlet openings of the nozzle for the cutting gas and the slit nozzle or the nozzles in an annular or polygonal arrangement, the cutting gas flow reaches sonic velocity. Compared to the prior art, the speed is lower, the pressure is higher and the shocks formed are weaker, which means that the energy of the gas able to be converted into work may also be increased compared to the prior art and losses due to strong shocks may be avoided. However, if the pressure ratio is less than 2, i.e. the absolute pressure at the outlet opening of the nozzle for the cutting gas is less than twice the absolute pressure at the outlet openings of the slit nozzles or the outlet openings of the nozzles, which are arranged in an annular or polygonal shape, sonic velocity is not reached in the cutting gas flow.

1-11. (canceled)

12. A processing head for laser beam cutting of components, in which, along its central longitudinal axis, a cutting gas feed is provided, through which a cutting gas as a first gas flow and a laser beam are directed through a nozzle arranged in the direction of the component onto a component to be cut in order to form a cutting gap, and the cutting gas feed is enclosed, at least in the region of the nozzle of the cutting gas feed, by an annular or polygonal slit nozzle or by an annular or polygonal arrangement of individual nozzles arranged separately from one another and is arranged such that the nozzle of the cutting gas feed is arranged in the centre of the circle or in the centre of gravity of the polygonal slit nozzle or of the polygonal arrangement of nozzles, and a second gas flow is directed through the annular or polygonal slit nozzle or the nozzles of the annular or polygonal arrangement in the direction of a surface of the component to be cut, and the pressure of the cutting gas supplied through the nozzle of the cutting gas feed and the pressure of the second gas flow, which flows through the annular or polygonal slit nozzle or the nozzles of the annular or polygonal arrangement, are each adjustable independently of one another, and a pressure of the cutting gas supplied through the nozzle of the cutting gas feed, at the outlet opening of the nozzle for the cutting gas, is greater than the pressure of the second gas flow at the outlet opening of the annular or polygonal slit nozzle or the outlet openings of the nozzles of the annular or polygonal arrangement and is at most three times as great, wherein
in the case of a polygonal slit nozzle or a polygonal arrangement of nozzles, a maximum distance parallel to the cutting gap to be formed of the respective outlet opening(s) arranged opposite is maintained which is smaller than the maximum distance of the outlet opening(s) arranged in an axial direction aligned perpendicular thereto, or
the distance between the outlet openings of the nozzle of the cutting gas feed and the annular or polygonal slit nozzle or the nozzles of the annular or polygonal arrangement to the surface of the component to be cut differs by a maximum of 1 mm and a distance in the range between 0.2 mm and 2 mm is maintained during the laser cutting processing.

13. The processing head according to claim 12, characterised in that the nozzle of the cutting gas feed, the annular or polygonal slit nozzle and/or the nozzles of the annular or polygonal arrangement is/are convergent in the direction of their outlet opening(s), so that the smallest free cross-section through the cutting gas or the second gas flow is/are arranged at the outlet opening of the nozzle for the cutting gas feed or the annular or polygonal slit nozzle or the outlet openings of the nozzles of the annular or polygonal arrangement.

14. The processing head according to claim 12, characterised in that the laser beam is directed coaxially through the nozzle of the cutting gas feed towards the component.

15. The processing head according to claim 14, characterised in that the laser beam has a beam cross-sectional area which fills at least 80% and at most 100% of the free cross-section of the nozzle of the cutting gas feed in the region of its outlet opening.

16. The processing head according to claim 12, characterised in that the smallest inner diameter of the nozzle of the cutting gas feed at the outlet opening corresponds to the gap width of the respective cutting gap to be formed with a deviation of at most ±20%.

17. The processing head according to claim 16, characterised in that the smallest inner diameter of the nozzle of the cutting gas feed at the outlet opening corresponds exactly to the gap width of the respective cutting gap to be formed and lies in the range between 0.5 mm and 2 mm.

18. The processing head according to claim 12, characterised in that the width of the slit of the annular or polygonal slit nozzle or the width or the outer diameter of the nozzles of the annular or polygonal arrangement corresponds at least to the width of the inner diameter of the nozzle of the cutting gas feed in the region of its outlet opening and is at most twice this inner diameter.

19. The processing head according to claim 12, characterised in that the outer diameter of the annular slit nozzle or the diameter of the annular arrangement of nozzles in the region of the outlet opening(s) is at least twice as large as the diameter of the nozzle of the cutting gas feed at its outlet opening and is at most 10.00 mm.

20. The processing head according to claim 12, characterised in that the inner lateral surfaces on the outwardly facing surface of the nozzle of the cutting gas feed, the annular or polygonal slit nozzle and/or nozzles of the annular or polygonal arrangement are tapered conically in the direction of the central longitudinal axis of the cutting gas feed towards the centre of the outlet opening of the nozzle on the cutting gas feed over a length starting at least 15 mm before the respective outlet opening is reached.

21. The processing head according to claim 12, characterised in that the pressure of the cutting gas supplied through the nozzle of the cutting gas feed at the outlet opening of the nozzle for the cutting gas is at most twice as great as the pressure of the second gas flow at the outlet opening of the annular or polygonal slit nozzle or the outlet openings of the nozzles of the annular or polygonal arrangement.

22. A method for laser beam cutting of components with a processing head for supplying cutting gas, by means of which a cutting gas is directed via a nozzle as a first gas flow and a laser beam in the direction of a component to be cut, so that a cutting gap is formed in the respective component, and via an annular or polygonal slit nozzle or nozzles, which are arranged in an annular or polygonal arrangement, in which the polygonal slit nozzle or a polygonal arrangement of nozzles maintains a maximum distance parallel to the cutting gap to be formed of the respective oppositely arranged outlet opening(s), which is smaller than the maximum distance of the outlet opening(s) arranged in an axial direction aligned perpendicular thereto, or
the distance between the outlet openings of the nozzle of the cutting gas feed and the annular or polygonal slit nozzle or the nozzles of the annular or polygonal arrangement to the surface of the component to be cut differs by a maximum of 1 mm and a distance in the range between 0.2 mm and 2 mm is maintained during the laser cutting processing,
a second gas flow is directed towards a surface of the component to be cut, wherein the pressure of the cutting gas supplied through the first nozzle and the pressure of the second gas flow supplied via the annular or polygonal slit nozzle or nozzles which are arranged in an annular or polygonal arrangement are set independently of one another and the pressure of the cutting gas supplied through the nozzle at the outlet opening of the nozzle for the cutting gas is at most three times greater than the pressure of the second gas flow at the outlet opening(s) of the annular or polygonal slit nozzle or nozzles which are arranged in an annular or polygonal arrangement.

23. The method according to claim 22, characterised in that the smallest inner diameter of the nozzle of the cutting gas feed at the outlet opening is selected so that it corresponds to the gap width of the respective cutting gap to be formed with a deviation of at most ±20%.

24. The method according to claim 23, characterised in that the smallest inner diameter of the nozzle of the cutting gas feed at the outlet opening is selected so that it corresponds to the gap width of the respective cutting gap to be formed exactly to the gap width of the respective cutting gap to be formed.

25. The method according to claim 23, characterised in that a pressure of the cutting gas supplied through the nozzle is set at the outlet opening of the nozzle for the cutting gas which is at least 1.5 times as great and at most twice as great as the pressure of the second gas flow at the outlet opening(s) of the annular or polygonal slit nozzle or the nozzles of the annular or polygonal arrangement.

26. The method according to claim 25, characterised in that a pressure of the cutting gas supplied through the nozzle is set at the outlet opening of the nozzle for the cutting gas which is at least 1.7 and at most 1.9 times as great as the pressure of the second gas flow at the outlet opening(s) of the annular or polygonal slit nozzle or the nozzles of the annular or polygonal arrangement.
